(19) United States
(12) Patent Application Publication
(10) Pub. No.: US 2016/0288401 A1
(43) Pub. Date: Oct. 6, 2016

(54) HEATING CHANNEL UNIT, METHOD FOR PRODUCING A HEATING CHANNEL UNIT, AND FOLDING DEVICE

(71) Applicant: KIEFEL GmbH, Freilassing (DE)

(72) Inventor: Wolfgang STURANY, Ainring (DE)

(21) Appl. No.: 15/088,565

(22) Filed: Apr. 1, 2016

(30) Foreign Application Priority Data
Apr. 4, 2015 (DE) 10 2015 004 195.9
Mar. 15, 2016 (DE) 10 2016 003 096.8

(51) Int. Cl. B29C 53/84; B29C 35/04; B29C 53/02

(52) U.S. Cl. CPC B29C 53/84; B29C 53/02; B29C 35/045; B33Y 80/00

(57) ABSTRACT

A heating channel unit of a folding device for folding a border of a decorative layer about a carrier part, includes a channel and a plurality of outlets from the channel, with at least a portion of the heating channel unit being produced via an additive production method.

### CROSS-REFERENCE TO RELATED APPLICATIONS

This application is related to and claims the benefit of German Patent Application No. DE 10 2015 004 195.9, filed on Apr. 4, 2015, and German Patent Application No. DE 10 2016 003 096.8, filed on Mar. 15, 2016, the contents of which are herein incorporated by reference in their entirety.

### TECHNICAL FIELD

The disclosure relates to a heating channel unit of a folding device for folding a border of a decorative layer about a carrier part, comprising a channel and a plurality of outlets from said channel.

The disclosure further relates to a method for producing a heating channel unit for heating a border of a decorative layer, in which a channel of the heating channel unit is provided with a plurality of outlets allowing hot air to exit.

The disclosure also relates to a folding device for folding a border of a decorative layer about a carrier part comprising a heating channel unit for heating the border of the decorative layer.

### BACKGROUND

Generic folding devices with a heating channel unit for heating at least one border area of a decorative layer of a decorative layer have been known from prior art for quite some time, for example from the automotive industry.

In an adhesive folding method, for example for folding a border of a decorative layer for an interior panel of an automobile, such as a film border of lateral door panels of vehicles, either an adhesive is used that can be thermally activated or the plastic body per se is heated with hot air and subsequently folded with mechanic slides.

Such folding devices are therefore used for the production of parts, which are particularly composed of a carrier part and a decorative layer arranged thereat, with the part being laminated with the decorative layer and thus is processed in order to obtain visually appealing and nice areas, for example at a functional part in a passenger cabin of a motor vehicle or the like.

For example, such functional components represent particularly panels at door areas, dashboards, glove compartments, or center consoles.

For example, a device for the folding of panels, free from adhesives, is known from the publication DE 295 07 067 U1, for example of inner panels of automobiles or the like. This device is characterized in a heating device with a heating channel unit by which the surface of an inner contour of a carrier part is heated in the folding area and this way it is partially melted such that the heated and/or partially melted surface is rendered adhesive for the decorative layer. The heating channel unit comprises here a channel provided with outlets, such as holes and/or slits, by which hot air can be guided to the surface to be heated.

Furthermore, other folding devices are known in which the inner side of a border area of a decorative layer is heated and thus rendered adhesive such that this border area of the decorative layer subsequently can be adhered and this way permanently fastened at the carrier part. These other folding devices are also characterized in a heating channel unit for heating the border of the decorative layer, which shows a channel with a plurality of outlets through which hot air can exit from the channel and can flow to the decorative layer in order to heat particularly the border of the decorative layer to be folded and adhered.

In the folding devices of prior art particularly the cannel conducting the hot air shows a progression adjusted to the contour of the carrier part and/or the decorative layer in order to allow hot air to securely reach all areas to be melted in the areas to be partially melted.

Here, parts of the heating channel unit are given, particularly also the channel showing the outlets, frequently comprising a metal tube, which is appropriately heat-resistant for guiding the hot air.

Conventionally, the channel is either expensively cut or alternatively round or rectangular tubes are manually bent, following the contour of the carrier part, and subsequently they are segment by segment welded or soldered to each other. Then, holes or the like must be drilled into these tubes through which the hot air exits.

In case of simple contours, this channel can be bent and adjusted with relative ease to the progression of the respective contour. However, it is easily discernible that the production of such a heating channel unit, particularly a respective channel, is relatively difficult especially in case of more challenging contours. To this regard it is frequently necessary that the heating channel unit and/or the channel to be assembled from several channel segments in order to allow realizing the desired form.

In particular, the functional parts of interior compartment of vehicles, constantly designed anew and in a more complex fashion, aggravate the production of appropriately formed heating channel units and/or channels such that the production of such heating channel units becomes increasingly more expensive as well. This leads to considerable surcharges for the provision of folding devices.

### SUMMARY

The disclosure is therefore based on further developing generic folding devices and particularly their heating channel units such that they themselves can be produced for more complicated functional parts with reasonable expense and thus cost-effectively.

The disclosure provides a heating channel unit of a folding device for folding a border of a decorative layer about a carrier part comprising a channel and a plurality of outlets out of said channel, with the heating channel unit being characterized in that at least a portion of the heating channel unit is produced via an additive production method.

Unlike classical subtractive production methods, such as cutting, drilling, machining or the like, such additive production methods are characterized, in that the materials for producing a part are essentially added layer by layer. In the present case, by this additive production method those production processes preferably can be even omitted completely, which are based on bonding methods such as welding, soldering, or the like.

Advantageously, with the help of additive production methods parts with complicated geometries, particularly allocated to a heating channel unit, can be produced in a relatively simple and cost-effective fashion.

This is based particularly in that the heating channel unit at least partially can be generated essentially in a single production process and preferably in a single production step.

To this regard, the disclosure provides a method for producing a heating channel unit for heating a border of a decorative layer in which a channel of the heating channel unit is provided with a plurality of outlets for hot air to exit, with the channel being produced generatively.

This way particularly the channel of the heating channel unit can be produced in a monolithic fashion. For this purpose, an additive production method is suitable as described above.

The production of the heating channel unit can be further simplified when the channel and the outlets are jointly produced in a generative fashion.

It is understood that the outlets provided in the channel may be produced differently as well, though.

If the heating channel unit is at least partially produced from a single data set, the heating channel unit can be produced in an even easier fashion.

This single data set includes preferably all data required for the generative production.

It is understood that different additive production methods can be used for the production of the heating channel unit and/or parts thereof.

It has shown that it is particularly advantageous when at least a part of the heating channel unit is produced in a 3D-printing method, particularly in a 3D-laser printing method.

In particular, such methods are particularly suited for generating complicated geometries on the heating channel unit.

Another advantage of the disclosure to be particular emphasized is given in that especially those sections of the heating channel unit can be advantageously produced through which a fluid, such as hot air, is guided because such areas can be produced with continuous and particularly smooth interior surfaces.

This is caused among other things in that parts of the heating channel unit produced in the sense of the disclosure can be embodied almost without any interruptions, thus without welding seams or the like.

With regards to the hot air required, here less friction loss develops so that the folding device can be operated not only more effectively but the hot air can also be supplied more homogenously to the area of the decorative layer to be heated, which in turn allows the border of the decorative layer to be heated more evenly.

This way alone the quality of the connection between the border of the decorative layer and the carrier part can be significantly improved.

Here, a preferred variant of the embodiment provides that at least a portion of the channel is produced by such an additive production method, particularly 3D-printing.

In particular, the channel extending essentially parallel in reference to the border of the decorative layer can be produced excellently in a 3D-printing process.

This way an individual design but also an interruption-free and particularly smooth interior of such a channel can be realized in a very problem-free fashion.

Further, it is particularly beneficial if at least a portion of the outlet is produced via an additive production method, particularly via 3D-printing. This way the channel and even the outlets, provided in large numbers, can be preferably produced jointly in a single generative production step.

With the additive production process suggested in the sense of the disclosure even the form of an outlet can be produced individually with regards to its design and particularly its production technology.

For example, the outlets are embodied as holes or slits, however they may also be formed almost arbitrarily.

In particular, the outlets formed at the heating channel unit may show shapes which in production and/or manufacturing methods previously suggested could not be realized or only with extreme expense.

More individual forms of outlets of a channel of a heating channel unit of a folding device are advantageous, though, and have been desired for quite some time, because this way a more targeted and/or effective heating of a border of a decorative layer is possible.

Furthermore it is advantageous if hot air—guiding elements for conducting hot air are produced at least partially via an additive production method, in particularly by way of 3D-printing. This way, the channel and the hot air—guiding elements can be produced jointly, preferably in a single generative production step.

Hot air—guiding elements produced in this fashion can assume almost any shape and can be formed and/or arranged inside the channel without any problems. This way, such hot air—guiding elements can be produced even inside the channel of the heating channel unit without major expenses.

Via such additional hot air13 guiding elements the hot air can be fed to the heating channel unit in a more targeted fashion.

The production of the heating channel unit can be further facilitated and generally improved if shoulder elements, projecting from the channel towards the outside for limiting a heated chamber between the channel and the border of the decorative layer, are produced via an additive production process, at least partially, particularly in the 3D-printing process, because the channel and the shoulder elements can be produced jointly, preferably in a single generative production step.

In the past, such shoulder elements had to be welded, soldered, or adhered to the exterior of the channel, requiring at least one additional production step, here.

Advantageously such shoulder elements can now be generated directly during the production of the channel, allowing to further simplify the production of the heating channel unit overall.

It is also advantageous when the connection tube elements for introducing hot air into the channel are at least partially produced via an additive production method, particularly 3D-printing. This way, the channel and connection elements can be produced jointly, preferably in a single generative production step.

Such connection tube elements, which generate a fluidic connection between an air heating device and the channel, can directly be produced jointly with the channel if the present heating channel unit is produced at least partially via an additive production method.

Even transitions between the channel and the connection tube elements may be designed in a more variegated fashion when additive production methods are used, so that they can be adjusted to individual requirements.

In this context it is particularly advantageous when transitions of openings between the connection tube elements and the channel are designed like funnels because this realizes an advantageous flow behavior for the hot air.

An individual adjustment of the flow behavior in parts of the heating channel unit can be further developed when the channel, the outlets, and/or the connection tube elements each show different diameters.

If the channel shows a progression with an alternating cross-section, here hot air flowing through it can be guided more individually adjusted and more precisely.

This applies similarly when outlets show a changing cross-section over their progression.

The same applies with regards to the connection tube elements, if at least some of them show changing cross-sections over their progression.

Such different cross-sections can be easily produced at the given heating channel unit in the sense of the disclosure via an additive production method.

Furthermore it is advantageous if the channel, the outlets, hot air guiding elements, connection tube elements, and/or laterally projecting shoulder elements are produced jointly in one piece, at least partially.

In the sense of the disclosure the term “in one piece” describes a part which is characterized in a homogenous and/or monolithic material structure.

If this part is produced in a monolithic fashion, this part is characterized in particularly such that it is free from seams, such as welding, soldering, and/or adhesion sites.

If the channel is produced in its entirely in a monolithic fashion, i.e. with its outlets, hot air—conducting elements, connection tube elements, and/or laterally projecting shoulder elements, to the extent provided, the production of the heating channel unit can be significantly simplified in general.

Such sections and/or parts of the heating channel unit produced in one piece are particularly advantageously also in that, with regards to the hot air to be conducted, less flow irritations develop so that any hot air flowing through the heating channel unit can be guided more effectively, i.e. with less eddying and thus also with less flow loss.

The heating channel unit can be further improved in its design when the heating element is made from parts. In particular with regards to assembly tasks it may be beneficial if the heating channel unit is assembled from at least two parts, which are preferably generated via an additive production method.

Furthermore, individual parts of a first heating channel unit may also be used for additional heating channel units so that heating channel units can be assembled in a modular fashion. This allows rendering additional cost benefits.

It is understood that all parts and/or functional areas of the heating channel unit described here, such as the channel, outlets, hot air—guiding elements, shoulder elements, and/or connection tube elements, can be produced with a high degree of individualism when they are produced in a laser-sintering method.

The disclosure also provides a folding device for folding a border of a decorative layer about a carrier part, with the folding device being characterized in a heating channel unit for heating the border of the decorative layer according to the features described here.

If the folding device is equipped with the present heating channel unit, the entire folding device can be produced easier and in a more cost effective fashion.

Additionally, functional parts covered with a decorative layer can be produced in a considerably more precise fashion.

Depending on a concrete embodiment of the disclosure therefore most different advantages can be yielded, either individually or in groups, or all of them combined.

For example, the freedom of fluidic design and shape possible with the present method is advantageous.

In particular, the 3D-printing method mentioned allows changes of radii or cross-sections, which in conventional and/or subtractive methods, such as cutting, machining, drilling, or the like cannot be implemented at all, or only to a limited extent.

Further, compared to manual productions here particularly higher precision can be yielded because a precise and homogenous distance can be ensured between the channel of the heating channel unit and a carrier part. In prior art this precision is only floating in the millimeter range.

3D-methods particularly used in the sense of the disclosure allow furthermore a production of the present channel without any tensions. In conventional channels made from tubes tensions caused by the production method are “frozen” inside the material, which particularly in connection with hot air (e.g. >200 ° C.) are released, resulting in the channel of the heating channel unit potentially twisting. This way, then a precise distance from the carrier part or the cover layer cannot be ensured any longer, here.

The 3D-printers preferably used here essentially represent machines (here analogously called “printers”) which generate three-dimensional work pieces layer by layer.

The production occurs computer controlled from one or more liquid or solid material according to predetermined dimensions and shapes (CAD).

During the production, physical or chemical curing or melting processes occur. Typical materials for 3D-printing are plastics, synthetic resins, ceramics, and metals.

### BRIEF DESCRIPTION OF THE DRAWINGS

Additional features, effects, and advantages of the present disclosure are further explained based on the attached drawing and the following description, in which as an example a heating channel unit generated in an additive manufacturing process is illustrated and described with regards to its channel.

In the drawings:

FIG. 1 schematically a perspective top view of a channel of a heating channel unit of a folding device produced in an additive production method; and

FIG. 2 schematically a detailed bottom view of a section of the channel of the heating channel unit shown in FIG. 1.

### DETAILED DESCRIPTION OF THE DRAWINGS

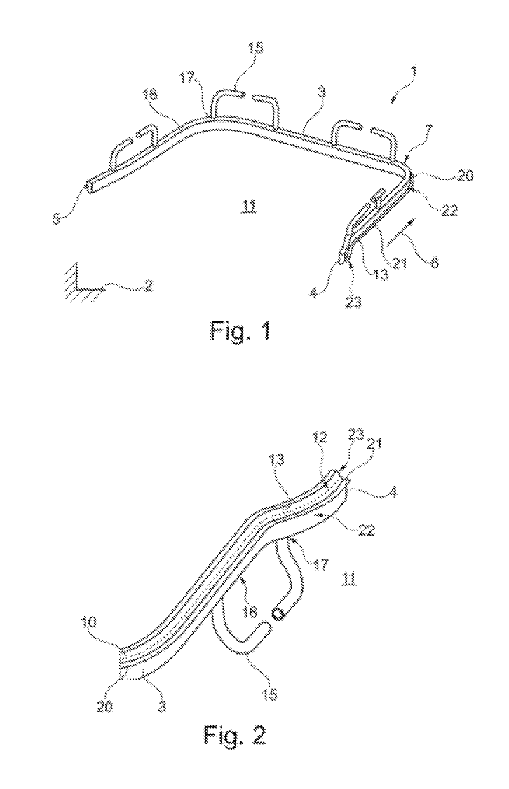

The heating channel unit 1 displayed in FIG. 1 of a folding device 2, not shown in greater detail, for folding a border of a decorative layer about a carrier part is shown according to the illustrations of FIGS. 1 and 2 regarding its channel 3 for guiding heated air and/or hot air (not explicitly marked here) heated by an air heater.

The channel 3 is essentially U-shaped and shows here a form which is repeatedly bent spatially in a three-dimensional fashion from a first end 4 of the channel 3 to a second end 5 of the channel 3 in the longitudinal direction 6 of the channel 3, as particularly clearly discernible in the illustration according to FIG. 2.

In this regard, the channel 3 of the heating channel unit 1 already shows a more elaborately shaped channel progression.

This channel 3 therefore represents an essential part 7 of the heating channel unit 1.

As also clearly discernible according to FIG. 2, the heating channel unit 1 shows at its channel 3 a plurality of outlets 10 (here marked only as an example), allowing hot air guided through the channel 3 to exit towards the environment 11 in order to heat a border area of a decorative layer not shown in greater detail here, so that this decorative layer on the one side is folded with its border area on the one side easier about an edge of a carrier part and can abut the carrier part there accordingly well. On the other side, the interior of the decorative layer, which is made to effectively contact the carrier part is partially melted and thus rendered adhesive such that the border area of the decorative layer is compressed to the carrier part with a pressure applied by a plunger, not shown here, and thus permanently and undetachably adhered thereto.

To this regard, the outlets 10 inserted in the channel 3 represent flow holes (here not explicitly marked separately) of the heating channel unit 1, through which the hot air introduced into the channel 3 can exit in a targeted fashion.

The outlets 10 are arranged with their outlet openings 12 at a broadside 13 of the channel 3 facing towards the outside.

The air heated at the air heater of the folding device 2 until it is hot air is fed to the channel 3 through several connection tube elements 15 (here only marked once as an example).

In this exemplary embodiment the connection tube elements 15 are arranged at a narrow side 16 of the channel 3, with the connection tube elements 15 transferring to the channel 3 at opening transitions 17.

Here, the air input openings, not shown, between the connection tube elements 15 and the channel 3 are arranged essentially at a right angle in reference to the outlet openings 12 of the outlets 10.

Further, the heating channel unit 1 comprises a shoulder element 20, which extends at the exterior broadside 13 of the channel 3 in the longitudinal extension 6 of the channel 3 from the first end 4 of the channel 3 to the second end 5 of the channel 3.

This shoulder element 20 is embodied as a thin elevation 21, and the shoulder element 20 projects in reference to the longitudinal extension 6 of the channel 3 radially towards the outside beyond the exterior 22 of the channel 3.

The shoulder element 20 forms here an end section of a hot air operating area 23 and/or a stop for the border of the decorative layer to be folded, with an end section of the decorative layer and the outlet openings 12 of the channel 3 being made to overlap for heating said border section.

The outlet openings 12 are here located underneath the radially projecting shoulder element 20, while the connection tube elements 15 are arranged above the radially projecting shoulder element 20.

The channel 3 produced in this fashion with its repeatedly bent progression along its longitudinal extension 6, comprising a plurality of outlets 10, with the connection tube elements 15 and with the radially projecting shoulder element 20 here being advantageously produced and embodied in one piece, with this complex channel 3 of the heating channel unit 1 being produced and/or manufactured via an additive production method.

Stated more precisely, the heating channel unit 1 in this exemplary embodiment is produced and/or generated with a 3D-laser printing method.

The term in one piece represents in the sense of the disclosure that the material structure of at least the components of the heating channel unit 1 described here shows at least a continuously homogenous structure.

In other words, this means that the heating channel unit 1 shown in FIGS. 1 and 2 has no bonding sites, generated by a welding, soldering, and/or adhesive connection.

Therefore, the heating channel unit 1 shown here can be produced in a single production step, significantly simplifying the production of the folding device 2 overall.

It is understood that the above explained exemplary embodiment represents only a first embodiment of the heating channel unit according to the disclosure. Therefore, the embodiment of the disclosure overall is not limited to this first exemplary embodiment.

All features disclosed in the documents are claimed to be essential for the disclosure to the extent they are novel in reference to prior art, individually or in combinations.

1. A heating channel unit of a folding device for folding a border of a decorative layer about a carrier part, comprising a channel and a plurality of outlets from said channel, wherein at least a portion of the heating channel unit is produced via an additive production method.

2. A heating channel unit according to claim 1, wherein at least a portion of the heating channel unit is produced in a 3D-printing method.

3. A heating channel unit according to claim 1, wherein at least a portion of the channel is produced via an additive production method.

4. A heating channel unit according to claim 1, wherein at least a portion of the outlet is provided via an additive production method.

5. A heating channel unit according to claim 1, wherein a plurality of hot air guiding elements configured for conducting hot air are produced at least partially via an additive production method.

6. A heating channel unit according to one of the previous claim 1, wherein a plurality of shoulder elements projecting from the channel towards the outside are provided for limiting the heated space between the channel and the border of the decorative layer, at least partially via an additive production process.

7. A heating channel unit according to claim 1, wherein a plurality of connection tube elements for introducing hot air into the channel are produced at least partially via an additive production method.

8. A heating channel unit according to claim 1, wherein a plurality of opening transitions are embodied like funnels between the connection tube elements and the channel.

9. A heating channel unit according to claim 1, wherein the channel, the outlets, and/or the connection tube elements each show different cross-sections, which are produced via an additive production method, particularly in the 3D-printing method.

10. A heating channel unit according to claim 1, wherein the channel, the outlets, the hot air guiding elements, the connection tube elements, and/or the laterally projecting shoulder elements are produced at least partially in one piece.

11. A heating channel unit according to one of the previous claims 1, wherein the heating channel unit is assembled from a plurality of parts.

12. A method for the production of a heating channel unit for heating a border of a decorative layer, in which a channel of the heating channel unit is adjusted to a contour of a carrier part to be provided with a decorative layer, wherein the channel is produced in a generative fashion in order to adjust the channel to the progression of the contour of the carrier part.

13. A method according to claim 12, wherein the channel and a plurality of outlets arranged therein configured for hot air exiting are generated jointly in a generative fashion.

14. A method according to claim 12, wherein the heating channel unit is produced at least partially based on a single data set.

15. A folding device for folding a border of a decorative layer about a carrier part comprising a heating channel unit for heating the border of the decorative layer, wherein a heating channel unit configured for heating the border of the decorative layer according to claim 1.
